(19) United States
(12) Patent Application Publication
(10) Pub. No.: US 2025/0312212 A1
(43) Pub. Date: Oct. 9, 2025

(54) Patient Transfer Chair Device

(71) Applicants: George Amegin, Edinburg, TX (US); Avijit Mukherjee, Alamo, TX (US); Diana Mata, Edinburg, TX (US)

(72) Inventors: George Amegin, Edinburg, TX (US); Avijit Mukherjee, Alamo, TX (US); Diana Mata, Edinburg, TX (US)

(21) Appl. No.: 18/630,101

(22) Filed: Apr. 9, 2024

(51) Int. Cl. A61G 5/14; A61G 5/12; A61G 15/02

(52) U.S. Cl. CPC A61G 5/14; A61G 5/125; A61G 15/02

(57) ABSTRACT

A patient transfer chair device is provided. The device is comprised of a wheeled base with a rotating platform and a chair. During use, a user can place their legs onto the platform and stand, wherein the platform can then be rotated such that the user is positioned above a chair of the base. Then, a user can sit into the chair and may be secured into the chair via at least one seat belt and/or armrest. Then, the entire device can be wheeled to a desired location to transport the user.

### CROSS-REFERENCE TO RELATED APPLICATION

The present application claims priority to, and the benefit of, U.S. Provisional Application No. 63/502,667, which was filed on May 15, 2023, and is incorporated herein by reference in its entirety.

### FIELD OF THE INVENTION

The present invention relates generally to the field of patient transfer devices. More specifically, the present invention relates to a patient transfer chair device that allows a user to be easily transferred from a lying position on a bed to a sitting position on a chair of the device. Accordingly, the present disclosure makes specific reference thereto. Nonetheless, it is to be appreciated that aspects of the present invention are also equally applicable to other like applications, devices, and methods of manufacture.

### BACKGROUND

Individuals with limited physical strength and dexterity often face significant challenges when it comes to daily activities, particularly when trying to get in and out of bed safely. For many, the simple act of getting out of bed can be fraught with risks. Without timely assistance from a family member, caregiver, or a trained medical professional, these individuals are at an increased risk of slipping and falling, potentially leading to severe injuries.

Furthermore, in medical environments like hospitals or hospice care facilities, the process of transferring patients between chairs and beds or moving them from one position to another is not only challenging but requires skill and expertise. Such mobility restrictions and limitations can be mentally taxing and emotionally frustrating, adding to the burdens that these individuals already endure on a daily basis.

Therefore, there exists a long-felt need in the art for a device that aids in allowing an individual to be transferred from a bed to a chair. There also exists a long-felt need in the art for a patient transfer chair device. More specifically, there exists a long-felt need in the art for a patient transfer chair device that allows a user to be transferred from a bed to a chair in a safe and efficient manner. In addition, there exists a long-felt need in the art for a patient transfer chair device that allows a user to be transferred from a bed to a chair in a safe and efficient manner wherein the device then allows a user to be easily transported once the transfer is complete.

The subject matter disclosed and claimed herein, in one embodiment thereof, comprises a patient transfer chair device. The device is comprised of a wheeled base with a rotating platform and a chair. During use, a user can place their legs onto the platform and stand, wherein the platform can then be rotated such that the user is positioned above a chair of the base. Then, a user can sit into the chair and may be secured into the chair via at least one seat belt and/or armrest. Then, the entire device can be wheeled to a desired location to transport the user.

In this manner, the patient transfer chair device of the present invention accomplishes all the forgoing objectives and provides a device that aids in allowing an individual to be transferred from a bed to a chair. More specifically, the device allows a user to be transferred from a bed to a chair in a safe and efficient manner. Further, the device then allows a user to be easily transported once the transfer is complete.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a patient transfer chair device. The device is primarily comprised of a base having at least one wheel, at least one rotating platform, and at least one chair. The device allows a user to stand on the platform from a bed (or other position) such that the platform rotates the user onto the chair.

The device is comprised of a base, wherein the bottom surface of the base is comprised of at least one wheel that allows the base to roll and be repositioned/transported as needed. In one embodiment, the wheel is comprised of at least one lock that inhibits motion of the wheel such that the base does not move when a user is standing on the device during use.

The top surface of the base is comprised of at least one platform that preferably attaches to the top surface via at least one vertical axle. The axle, and attached platform, can rotate 360 degrees relative to the vertical axis of the base via the motor.

The top surface is also comprised of at least one chair. The chair is comprised of at least one vertical frame member and at least one seat. Although in different embodiments the chair may be any size, style, shape, and configuration of chair and/or transfer chair known in the art. In one embodiment, the seat (and/or a backrest) can move upwards and downwards along the vertical frame member to accommodate users of different heights. In this embodiment, the vertical frame member may have at least one motorized track that is powered by the motor to which the seat and/or backrest is attached to. Raising/lowering of the seat and/or backrest can be controlled via at least one button. The chair may also be comprised of at least one arm rest of any style and configuration. In a further embodiment, a user can be secured in the chair via at least one vertical, horizontal, and/or diagonal seat belt that attaches around a user.

The present invention is also comprised of a method of using the device. First, a device is provided comprised of a base comprised of at least one wheel with at least one lock, at least one rotating platform on the top surface of the base, and at least one chair on the top surface of the base. Then, the device can be positioned next to a bed or other piece of furniture or surface on which a user may be lying in an elevated position. Next, the wheel can be locked via the lock to prevent movement of the wheel. Then, a user can sit on the edge of the bed and place their feet on the platform. Next, the user can stand on the platform, wherein a second user (i.e., a caregiver) presses at least one button to rotate the platform until the user can lower their body into the chair. Then, the second user can disengage the lock such that they can wheel the user to a secondary location while the user sits on the chair.

In another method of using the device, a device is provided comprised of a base comprised of at least one wheel with at least one lock, at least one rotating platform on the top surface of the base, and at least one chair on the top surface of the base, and at least one motor. Then, the device can be positioned next to a bed or other piece of furniture or surface on which a user may be lying in an elevated position. Next, the wheel can be locked via the lock to prevent movement of the wheel. Then, a user can sit on the edge of the bed and place their feet on the platform. Then, a user can press at least one button in order to raise or lower the seat and/or backrest of the chair to a desired height. Next, the user can stand on the platform, wherein a second user (i.e., a caregiver) presses at least one button to rotate the platform until the user can lower their body into the chair. Next, at least one armrest can be manually (or remotely via the button) folded downwards to secure the user in the chair. Then, the secondary user can secure the user into the chair via fastening at least one seat belt around the user. Then, the second user can disengage the lock such that they can wheel the user to a secondary location while the user sits on the chair.

Accordingly, the patient transfer chair device of the present invention is particularly advantageous as it provides a device that aids in allowing an individual to be transferred from a bed to a chair. More specifically, the device allows a user to be transferred from a bed to a chair in a safe and efficient manner. Further, the device then allows a user to be easily transported once the transfer is complete. In this manner, the patient transfer chair device provides a solution to easily transferring a patient from a lying position on a bed to a seated position in a chair.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a patient transfer chair device of the present invention while a user has their feet on the rotating platform in accordance with the disclosed architecture;

FIG. 2 illustrates a perspective view of one potential embodiment of a patient transfer chair device of the present invention while a user is standing on the rotating platform and grasping an armrest of the chair in accordance with the disclosed architecture;

FIG. 3 illustrates a perspective view of one potential embodiment of a patient transfer chair device of the present invention while a user is standing on the rotating platform and grasping an armrest of the chair in accordance with the disclosed architecture;

FIG. 4 illustrates a perspective view of one potential embodiment of a patient transfer chair device of the present invention while a user is sitting in the chair and secured by the seat belt in accordance with the disclosed architecture;

FIG. 5 illustrates a perspective view of one potential embodiment of a patient transfer chair device of the present invention wherein the armrests are folded upwards in accordance with the disclosed architecture;

FIG. 6 illustrates a flowchart of a method of using one potential embodiment of a patient transfer chair device of the present invention in accordance with the disclosed architecture; and

FIG. 7 illustrates a flowchart of a method of using one potential embodiment of a patient transfer chair device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that aids in allowing an individual to be transferred from a bed to a chair. There also exists a long-felt need in the art for a patient transfer chair device. More specifically, there exists a long-felt need in the art for a patient transfer chair device that allows a user to be transferred from a bed to a chair in a safe and efficient manner. In addition, there exists a long-felt need in the art for a patient transfer chair device that allows a user to be transferred from a bed to a chair in a safe and efficient manner wherein the device then allows a user to be easily transported once the transfer is complete.

The present invention, in one exemplary embodiment, is comprised of a patient transfer chair device primarily comprised of a base having at least one wheel, at least one rotating platform, and at least one chair. The device allows a user to stand on the platform from a bed (or other position) such that the platform rotates the user onto the chair.

The base of the device has a bottom surface comprised of at least one wheel that allows the base to roll and be repositioned/transported as needed. In one embodiment, the wheel is comprised of at least one lock that inhibits motion of the wheel such that the base does not move when a user is standing on the device during use. The top surface of the base is comprised of at least one platform that preferably attaches to the top surface via at least one vertical axle. The axle, and attached platform, can rotate 360 degrees relative to the vertical axis of the base via the motor.

The top surface is also comprised of at least one chair comprised of at least one vertical frame member and at least one seat. Although in different embodiments the chair may be any size, style, shape, and configuration of chair and/or transfer chair known in the art. In one embodiment, the seat (and/or a backrest) can move upwards and downwards along the vertical frame member to accommodate users of different heights. In this embodiment, the vertical frame member may have at least one motorized track that is powered by the motor to which the seat and/or backrest is attached to. Raising/lowering of the seat and/or backrest can be controlled via at least one button. The chair may also be comprised of at least one arm rest of any style and configuration. In a further embodiment, a user can be secured in the chair via at least one vertical, horizontal, and/or diagonal seat belt that attaches around a user.

The present invention is also comprised of a method of using the device. First, a device is provided comprised of a base comprised of at least one wheel with at least one lock, at least one rotating platform on the top surface of the base, and at least one chair on the top surface of the base. Then, the device can be positioned next to a bed or other piece of furniture or surface on which a user may be lying in an elevated position. Next, the wheel can be locked via the lock to prevent movement of the wheel. Then, a user can sit on the edge of the bed and place their feet on the platform. Next, the user can stand on the platform, wherein a second user (i.e., a caregiver) presses at least one button to rotate the platform until the user can lower their body into the chair. Then, the second user can disengage the lock such that they can wheel the user to a secondary location while the user sits on the chair.

In another method of using the device, a device is provided comprised of a base comprised of at least one wheel with at least one lock, at least one rotating platform on the top surface of the base, and at least one chair on the top surface of the base, and at least one motor. Then, the device can be positioned next to a bed or other piece of furniture or surface on which a user may be lying in an elevated position. Next, the wheel can be locked via the lock to prevent movement of the wheel. Then, a user can sit on the edge of the bed and place their feet on the platform. Then, a user can press at least one button in order to raise or lower the seat and/or backrest of the chair to a desired height. Next, the user can stand on the platform, wherein a second user (i.e., a caregiver) presses at least one button to rotate the platform until the user can lower their body into the chair. Next, at least one armrest can be manually (or remotely via the button) folded downwards to secure the user in the chair. Then, the secondary user can secure the user into the chair via fastening at least one seat belt around the user. Then, the second user can disengage the lock such that they can wheel the user to a secondary location while the user sits on the chair.

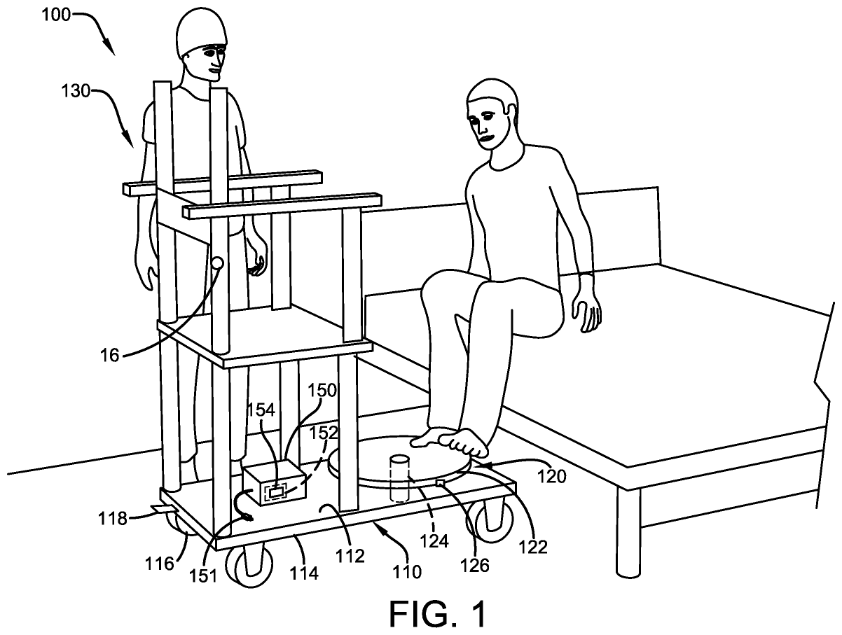

Referring initially to the drawings, FIG. 1 illustrates a perspective view of one potential embodiment of a patient transfer chair device 100 of the present invention while a user has their feet on the rotating platform 120 in accordance with the disclosed architecture. The device 100 is primarily comprised of a base 110 having at least one wheel 116, at least one rotating platform 120, and at least one chair 130. The device 100 allows a user to stand on the platform 120 from a bed (or other position) such that the platform 120 rotates the user onto the chair 130.

The device 100 is comprised of a base 110. The base 110 may be any size, shape, and configuration in different embodiments. The bottom surface 114 of the base 110 is comprised of at least one wheel 116. The wheel 116 allows the base 110 to roll and be repositioned/transported as needed. In one embodiment, the wheel 116 is comprised of at least one lock 118. The lock 118 inhibits motion of the wheel 116 such that the base 110 does not move when a user is standing on the device 100 during use. The wheel 116 and lock 118 may be any style of wheel and lock combination known in the art.

The top surface 112 of the base 110 is comprised of at least one platform 120. The platform may be any shape, size, and configuration in different embodiments. The platform 120 preferably attaches to the top surface 112 via at least one vertical axle 124. The axle 124, and attached platform 120, can rotate 360 degrees relative to the vertical axis of the base 110 via the motor 150. In one embodiment, the platform 120 rotates 360 degrees around the vertical axis of the axle 124, wherein the platform and axle 124 are not motorized.

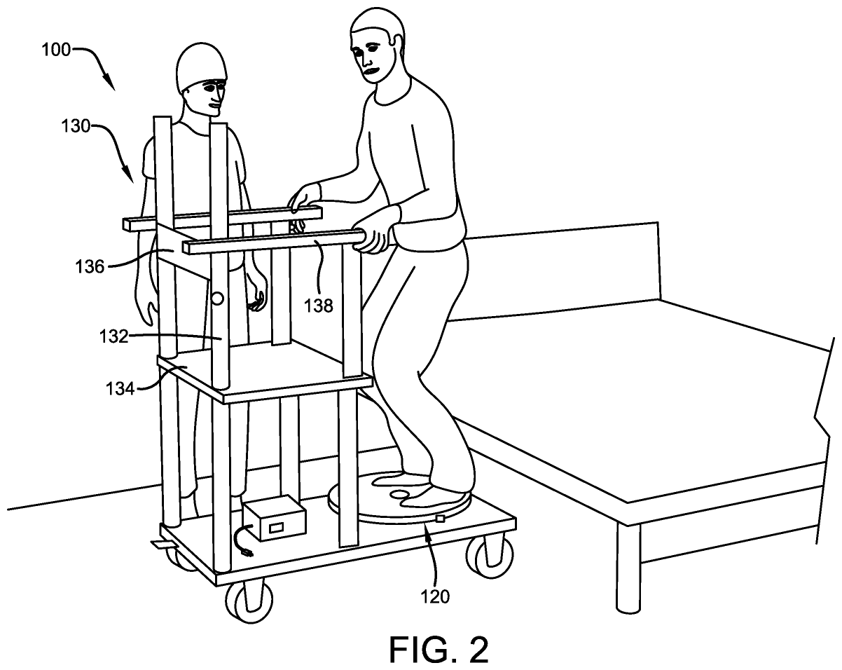

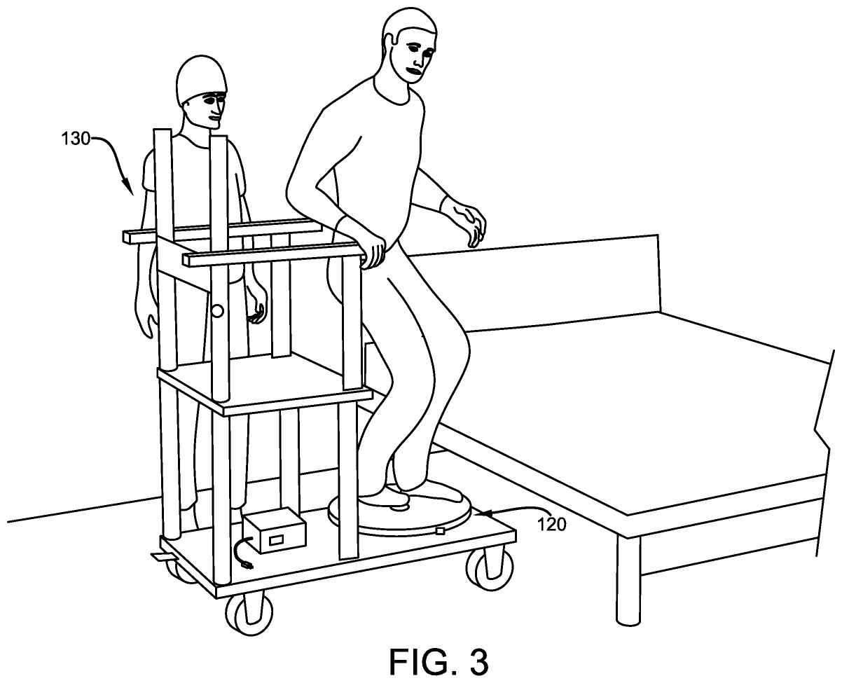

In one embodiment, the top surface 122 of the platform 120 is comprised of a material that promotes grip, such as but not limited to non-slip rubber. Said surface 122 may further be textured with a raised or recessed texture to further increase grip. This prevents a user from falling/slipping off the platform 120 while standing on the platform 120, as seen in FIG. 2 and FIG. 3. Motion of the platform 120 may further be locked via at least one lock 126 that secures the platform 120 to the base 110, preventing rotation.

The top surface 122 is also comprised of at least one chair 130. The chair 130 is comprised of at least one vertical frame member 132 and at least one seat 134. Although in different embodiments the chair 130 may be any size, style, shape, and configuration of chair and/or transfer chair known in the art. In one embodiment, the seat 134 is comprised of a waterproof, padded seat for durability and comfort. The seat 134 may also be comprised of at least one backrest 136 of the same construction, which may or may not attach to the seat 134 and/or vertical frame member 132. In one embodiment, the seat 134 (and/or backrest 136) can move upwards and downwards along the vertical frame member 132 to accommodate users of different heights. In this embodiment, the vertical frame member 132 may have at least one motorized track 139 that is powered by the motor 150 to which the seat 134 and/or backrest 136 is attached to. Raising/lowering of the seat 134 and/or backrest 136 can be controlled via at least one button 160.

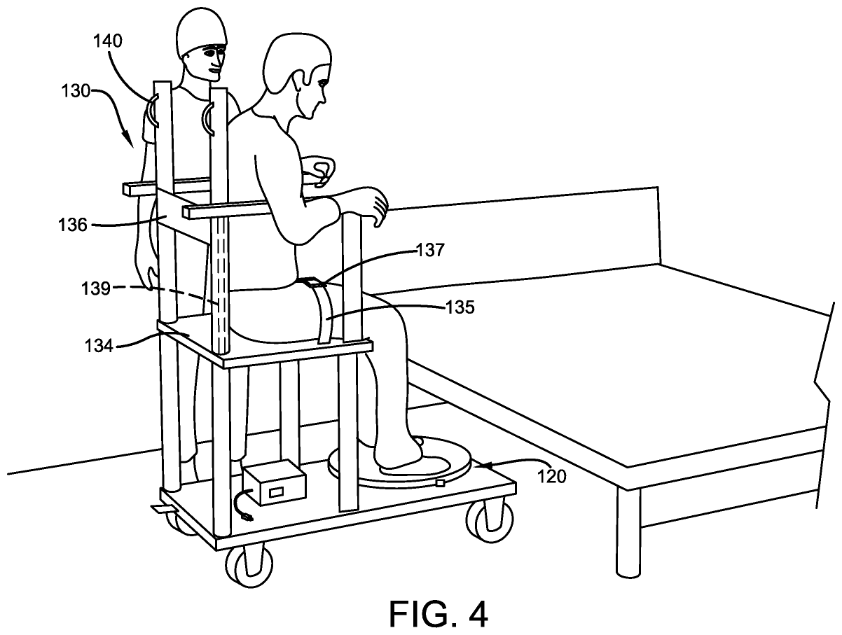

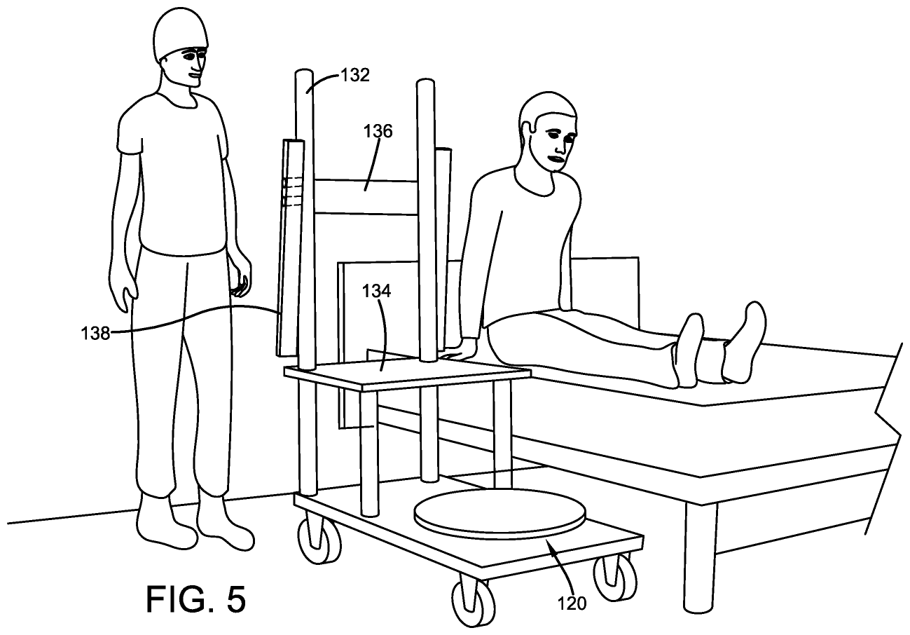

The chair 130 may also be comprised of at least one arm rest 138 of any style and configuration. In one embodiment, the armrest 138 is a folding armrest such that the armrest 138 can be folded upwards out of the way of the seat 134 (as seen in FIG. 5) when a user is initially transferred to the seat 134. Then, the armrest 138 can be unfolded downwards, as seen in FIG. 4, in order to secure the user in the chair 130 during transport. In one embodiment, the armrests 138 are motorized and the folding, unfolding, and positioning of the armrests 138 can be controlled by the button 160.

In a further embodiment, a user can be secured in the chair 130 via at least one vertical, horizontal, and/or diagonal seat belt 135 that attaches around a user, as seen in FIG. 4. The belt 135 may be attached to the seat 134 and/or backrest 136 and may be comprised of at least one fastener 137. The fastener 137 allows the belt 135 to be loosened, tightened, and secured and may be but is not limited to a clip, a buckle, etc.

The frame member 132 and/or any other portion of the device 100 may be comprised of at least one handle 140. The handle 140 may be of any size, configuration, and style known in the art. The handle 140 allows a caregiver to push the device 100 while a user sits on the chair 130.

The motor 150 may be any type known in the art, but is preferably an electric motor in wired or wireless electrical communication with the axle 124 and/or track 139. The motor 150 is comprised of at least one battery 152. The battery 152 may be removable and disposable or rechargeable in one embodiment. In another embodiment, the battery 152 is non-removable and rechargeable via at least one charging port 154, such as but not limited to a USB port. In one embodiment, the battery 152 can receive charge/power via at least one male power cord 151 of any type known in the art, such as but not limited to a male 110v/220v wall outlet cord and plug.

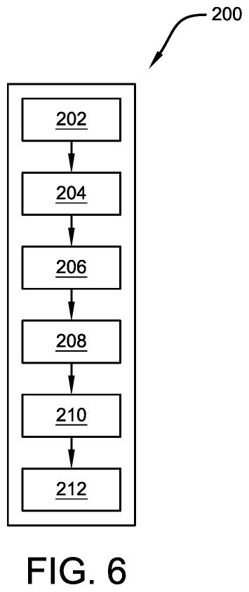

The present invention is also comprised of a method of using 200 the device 100, as seen in FIG. 6. First, a device 100 is provided comprised of a base 110 comprised of at least one wheel 116 with at least one lock 118, at least one rotating platform 120 on the top surface 122 of the base 110, and at least one chair 130 on the top surface 122 of the base 110 [Step 202]. Then, the device 100 can be positioned next to a bed or other piece of furniture or surface on which a user may be lying in an elevated position [Step 204]. Next, the wheel 116 can be locked via the lock 118 to prevent movement of the wheel 116 [Step 206]. Then, a user can sit on the edge of the bed and place their feet on the platform 120 [Step 208]. Next, the user can stand on the platform 120, wherein a second user (i.e., a caregiver) presses at least one button 160 to rotate the platform 120 until the user can lower their body into the chair 130 [Step 210]. Then, the second user can disengage the lock 118 such that they can wheel the user to a secondary location while the user sits on the chair 130 [Step 212].

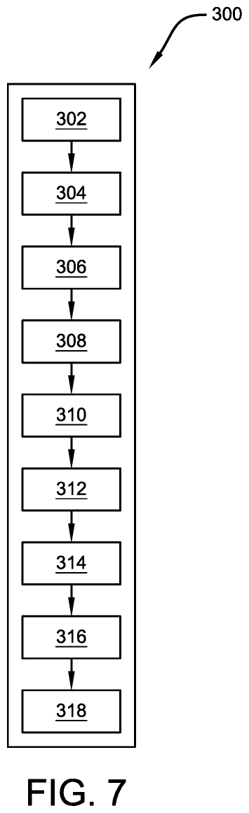

In another method of using 300 the device 100, as seen in FIG. 7, a device 100 is provided comprised of a base 110 comprised of at least one wheel 116 with at least one lock 118, at least one rotating platform 120 on the top surface 122 of the base 110, and at least one chair 130 on the top surface 122 of the base 110, and at least one motor 150 [Step 302]. Then, the device 100 can be positioned next to a bed or other piece of furniture or surface on which a user may be lying in an elevated position [Step 304]. Next, the wheel 116 can be locked via the lock 118 to prevent movement of the wheel 116 [Step 306]. Then, a user can sit on the edge of the bed and place their feet on the platform 120 [Step 308]. Then, a user can press at least one button 160 in order to raise or lower the seat 134 and/or backrest 136 of the chair 130 to a desired height [Step 310]. Next, the user can stand on the platform 120, wherein a second user (i.e., a caregiver) presses at least one button 160 to rotate the platform 120 until the user can lower their body into the chair 130 [Step 312]. Next, at least one armrest 138 can be manually (or remotely via the button 160) folded downwards to secure the user in the chair 130 [Step 314]. Then, the secondary user can secure the user into the chair 130 via fastening at least one seat belt 135 around the user [Step 316]. Then, the second user can disengage the lock 118 such that they can wheel the user to a secondary location while the user sits on the chair 130 [Step 318].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “patient transfer chair device” and “device” are interchangeable and refer to the patient transfer chair device 100 of the present invention.

Notwithstanding the forgoing, the patient transfer chair device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the patient transfer chair device 100 as shown in the FIGS. are for illustrative purposes only, and that many other sizes and shapes of the patient transfer chair device 100 are well within the scope of the present disclosure. Although the dimensions of the patient transfer chair device 100 are important design parameters for user convenience, the patient transfer chair device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A patient transfer chair device comprising:
a base comprised of a wheel;
a rotating platform positioned on a top surface of the base; and
a chair positioned on a top surface of the base.

2. The patient transfer chair device of claim 1, wherein the rotating platform rotates 360 degrees around the base.

3. The patient transfer chair device of claim 1, wherein the rotating platform is comprised of a non-slip rubber top surface.

4. The patient transfer chair device of claim 3, wherein the top surface is comprised of a raised or a recessed texture.

5. The patient transfer chair device of claim 1, wherein the chair is comprised of a seat.

6. The patient transfer chair device of claim 1, wherein the chair is comprised of a backrest.

7. The patient transfer chair device of claim 1, wherein the chair is comprised of a seat belt.

8. The patient transfer chair device of claim 1 further comprised of a handle.

9. A patient transfer chair device comprising:
a base comprised of a wheel, the wheel comprised of a lock;
a rotating platform attached to a top surface of the base via a vertical axle; and
a chair positioned on a top surface of the base, the chair comprised of a seat;
a motor;
a battery; and
a button.

10. The patient transfer chair device of claim 9, wherein the motor rotates the vertical axle.

11. The patient transfer chair device of claim 10, wherein the axle can rotate 360 degrees relative to a Y-axis of the base.

12. The patient transfer chair device of claim 9, wherein the chair is comprised of a backrest.

13. The patient transfer chair device of claim 9, wherein the chair is comprised of a seat belt.

14. The patient transfer chair device of claim 9, wherein the chair is comprised of an armrest.

15. The patient transfer chair device of claim 14, wherein the armrest is comprised of a folding armrest.

16. The patient transfer chair device of claim 9, wherein the chair is comprised of a vertical frame member.

17. The patient transfer chair device of claim 16, wherein the seat attaches to a motorized track of the vertical frame member and can be moved up and down the vertical frame member via the motor.

18. The patient transfer chair device of claim 15, wherein the armrest can be unfolded and unfolded by the motor.

19. A method of using a patient transfer chair device, the method comprising the following steps:
providing a patient transfer chair device comprised of a base comprised of a wheel, a rotating platform, and a chair;
positioning the device next to a bed;
locking the wheel via a lock of the wheel;
placing a foot of a user on the rotating platform from the bed;
standing up onto the rotating platform;
rotating the platform;
lowering a body of the user onto the chair; and
disengaging the lock and rolling the patient transfer chair device to transport the user.

20. The method of using a patient transfer chair device of claim 19 further comprised of a step of raising or lowering a seat of the chair.
